(19) United States
(12) Patent Application Publication
(10) Pub. No.: US 2017/0305793 A1
(43) Pub. Date: Oct. 26, 2017

(54) STONE PAINT FORMULATION AND METHODS FOR PRODUCING THE SAME

(71) Applicant: HERCULES LLC, Wilmington, DE (US)

(72) Inventors: Kelly Anne BRUSH, Newark, DE (US); Tarimala SOWMITRI, Newark, DE (US); Prachur BHARGAVA, Lafayette Hill, PA (US)

(73) Assignee: HERCULES LLC, Wilmington, DE (US)

(21) Appl. No.: 15/508,833

(22) PCT Filed: Aug. 31, 2015
(86) PCT No.: PCT/US15/47675

§ 371 Date: Mar. 3, 2017

Related U.S. Application Data
(60) Provisional application No. 62/046,391, filed on Sep. 5, 2014.

(51) Int. Cl. C04B 24/38; C04B 26/06; C09D 121/02; C04B 14/04; C04B 41/00; C04B 24/32; C09D 5/02; C04B 103/00; C04B 103/54; C04B 103/67

(52) U.S. Cl. CPC C04B 24/383; C04B 24/32; C04B 26/06; C09D 121/02; C09D 5/02; C04B 14/043; C04B 41/009; C04B 2103/54; C04B 2103/67; C04B 2103/0079

(57) ABSTRACT

The presently disclosed and/or claimed inventive concept(s) relates generally to a stone paint formulation. More particularly, the presently disclosed and/or claimed inventive concept(s) relates to a stone paint comprising a composition A and a composition B. The composition A comprises a latex emulsion, a rheology modifier, a coalescing agent, a biocide, a neutralizing agent and a solvent. The composition B comprises a sand. Additionally, the presently disclosed and/or claimed inventive concept(s) relates to a method of making the stone paint formulation by using the rheology modifier. The stone paint of the presently disclosed and/or claimed inventive concept(s) has enhanced resistance to water-whitening.

### BACKGROUND

### 1. Field of the Invention

The presently disclosed and/or claimed inventive process(es), procedure(s), method(s), product(s), result(s), and/or concept(s) (collectively referred to hereinafter as the “presently disclosed and/or claimed inventive concept(s)”) relates generally to a stone paint formulation. More particularly, but not by way of limitation, the presently disclosed and/or claimed inventive concept(s) relates to a stone paint formulation or a stone paint comprising a composition A and a composition B. The composition A comprises a latex emulsion, a rheology modifier, a coalescing agent, a biocide, a neutralizing agent and a solvent. The composition B comprises a sand. Additionally, the presently disclosed and/or claimed inventive concept(s) relates to a method of making the stone paint by using the rheology modifier. The stone paint of the presently disclosed and/or claimed inventive concept(s) has enhanced resistance to water-whitening.

### 2. Background of the Invention

Natural granite stone, a high-end decorative material, is very popular in the market. However, this natural granite stone has limited reserves with certain patterns and colors, and cannot be recycled. As a result, the use of natural granite stone as decorative building materials has its limitations. Stone paint has become popular in the field of architectural decoration. Stone paint is a coating that is mainly used in building surfaces. The coating has thick and dense texture, is cured hard, and looks like natural stone. In addition, the coating is very stable, fireproof, waterproof, acid and alkali resistance and is not faded quickly. The stone paint is widely used in construction applications, including but not limited to exterior, interior, as well as plastic stone garden areas. The stone paint is dignified, elegant, and imparts natural appearance.

Currently, hydroxyethyl cellulose (HEC) is commonly used as a rheology modifier in a typical stone paint formulation since it provides favorable rheological properties such as thickening, sprayability, thermal and viscosity stability, and biostability. However, the stone paint containing HEC demonstrates very poor water whitening. Water whitening occurs in the field when the stone paint is exposed to rain or water. As a result, the stone paint becomes whiter after water washing, which significantly impacts the appearance of the stone paint and reduces its service life. It is desired to find a new rheology modifier which can impart the requisite thickening, sprayability, thermal and viscosity stability, and storage stability with enhanced resistance to water whitening.

### DETAILED DESCRIPTION OF THE INVENTIVE CONCEPT(S)

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of ordinary skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein any reference to “one embodiment” or “an embodiment” means that a particular element, feature, structure, or characteristic described in connection with the embodiment is included in at least one embodiment. The appearance of the phrase “in one embodiment” in various places in the specification are not necessarily all referring to the same embodiment.

As used herein, the term “copolymer” shall be defined as a polymer(s) comprising two or more different monomers and should not be construed to mean a polymer comprising only two different monomers.

The presently disclosed and/or claimed inventive concept(s) encompasses a stone paint formulation and a stone paint applying the stone paint formulation. More particularly, but not by way of limitation, the presently disclosed and/or claimed inventive concept(s) relates to a stone paint formulation comprising a composition A and a composition B. The composition A comprises a latex emulsion, a rheology modifier, a coalescing agent, a biocide, a neutralizing agent and a solvent. The composition B comprises a sand. Additionally, the presently disclosed and/or claimed inventive concept(s) relates to a method of making the stone paint by using the rheology modifier.

The latex emulsion according to the presently disclosed and/or claimed inventive concept(s) can be acrylic emulsions. Acrylic emulsions are usually prepared by emulsion polymerization of one or more acrylic monomers. Acrylic monomers that contain a polar group are often used to stabilize the emulsion. These monomers include acrylic and methacrylic acids, and hydroxyalkyl acrylates and methacrylates. Introducing acid or hydroxyl functional groups into acrylic emulsions also makes them crosslinkable to form thermosetting coatings.

Any acrylic monomers known in the art can be used in the presently disclosed and/or claimed inventive concept(s). Suitable acrylic monomers can include, but are not limited to, acrylic acids, alkyl(meth) acrylic acids such as methyl acrylic acids, ionic acrylate salts, alkacrylic acids, ionic alkacrylate salts, haloacrylic acids, ionic haloacrylate salts, acrylamides, alkacrylamides, monoalkyl acrylamides, monoalkyl alkacrylamides, alkyl acrylates, alkyl alkacrylates, acrylonitrile, alkacrylonitriles, dialkyl acrylamides, dialkyl alkacrylamides, hydroxyalkyl acrylates, hydroxyalkyl alkacrylates, only partially esterified acrylate esters of alkylene glycols, only partially esterified acrylate esters of non-polymeric polyhydroxy compounds like glycerol, only partially esterified acrylate esters of polymeric polyhydroxy compounds, wet adhesion monomers, and multifunctional monomers such as divinyl benzene, diacrylates, for crosslinking functions, etc.

In one non-limiting embodiment, the acrylic monomers are selected from the group consisting of methyl acrylate, ethyl acrylate and methacrylate, butyl acrylate and methacrylate, iso-octyl acrylate and methacrylate, lauryl acrylate and methacrylate, stearyl acrylate and methacrylate, isobornyl acrylate and methacrylate, methoxy ethyl acrylate and methacrylate, 2-ethyoxy ethyl acrylate and methacrylate, dimethylamino ethyl acrylate and methacrylate, and combinations thereof.

An aromatic monomer and/or an amide monomer are often incorporated into acrylic emulsions as high-T_{g} monomers. Examples of such monomers containing aromatic groups can include, but are not limited to, styrene, methylstyrene, chlorostyrene, methoxystyrene and the like. Other suitable aromatic monomers containing aromatic groups include, but are not limited to, 2,4-diphenyl-4-methyl-1-pentene, 2,4-dimethylstyrene, 2,4,6-trimethylstyrene, 2,3,4,5,6-pentafluoro styrene, (vinylbenzyl)trimethylammonium chloride, 2,6-dichlorostyrene, 2-fluorostyrene, 2-isopropenylaniline, 3(trifluoromethyl)styrene, 3-fluorostyrene, α-methylstyrene, 3-vinylbenzoic acid, 4-vinylbenzyl chloride, a bromo styrene, 9-vinylanthracene, and combinations thereof. Examples of styrene acrylate can include, but are not limited to, a styrene ethyl acrylate copolymer, a styrene-methyl meth acrylate-n-butyl acrylate copolymer, and a styrene-butyl acrylate copolymer.

Examples of monomers containing amide groups can include, but are not limited to, methacrylamide, diacetone acrylamide, and acrylamide. Other suitable monomers containing amide groups can include, but are not limited to, N-vinylformamide, or any vinyl amide, N,N-dimethylacrylamide, N—(I,I-dimethyl-3-oxobutyl)(meth)acrylamide, N-(hydroxymethyl)(meth)acrylamide, N-(3-methoxypropyl)acrylamide, N-(butoxymethyl)acrylamide, N-(isobutoxymethyl)acryl(methacryl)amide, N-[tris(hydroxymethyl)methyl]acryl(methacryl)amide, 7-[4 (trifluoromethyl)coumarin](meth)acrylamide, 3-(3-fluorophenyl)-2-propenamide, 3-(4-methylphenyl)acrylamide, N-(tert-butyl)(meth)acrylamide, and combinations thereof.

The latex emulsion used in the presently disclosed and/or claimed inventive concept(s) can be a silicon modified latex. In one non-limited embodiment, the silicon modified latex can be a waterborne silicon acrylate latex polymer, which is disclosed by Ozdegar in U.S. Pat. No. 6,420,480. Its relevant disclosure is incorporated herein by reference.

The amounts of the latex emulsion used in the presently disclosed and/or claimed inventive concept(s) can be determined by those skilled in the art. In one non-limiting embodiment, the amount of dry latex emulsion is at least about 1 wt % based on the total weight of the composition A. In another non-limiting embodiment, the amount of dry latex emulsion is from about 2 wt % to about 50 wt % based on the total weight of the composition A. In yet another non-limiting embodiment, the amount of dry latex emulsion is from about 5 wt % to about 50 wt % based on the total weight of the composition A.

The rheology modifiers in the presently disclosed and/or claimed inventive concept(s) are nonionic cellulose ethers. Such nonionic cellulose ethers with improved properties can be used in stone paint formulation to improve water whitening but do not impact other properties of stone paint thus resulting in sustainable appearance. The nonionic cellulose ether can be methyl hydroxyethyl cellulose (MHEC), methyl hydroxypropyl cellulose (MHPC), methyl cellulose (MC), and mixtures thereof.

By combining hydroxyethyl, hydroxypropyl and methyl substitutions in a new and carefully controlled manner, novel methyl hydroxyethyl cellulose and methyl hydroxypropyl cellulose can show improved water whitening when they are used in stone paint formulations. The methyl hydroxyethyl cellulose has its unique combination of degree of substitution (DS) for methyl groups (MeDS) and molar substitution (MS) for hydroxyethyl groups (HeMS), expressed as [MeDS/HeMS+100*MeDS]. Similarly, the methyl hydroxypropyl cellulose has its unique combination of degree of substitution (DS) for methyl groups (MeDS) and molar substitution (MS) for hydroxypropyl groups (HpMS), expressed as [MeDS/HpMS+180*MeDS]. As used therein, the symbol “*” represents the multiplication operator. Methods for determining MeDS, HeMS and HpMS are described in more details in the Examples.

For MHEC, [MeDS/HeMS+100*MeDS] is greater than 180. In one non-limiting embodiment, [MeDS/HeMS+100*MeDS] is in a range of from about 183 to about 220.

For MHPC. [MeDS/HpMS+180*MeDS] is greater than 295. In one non-limiting embodiment, [MeDS/HpMS+180*MeDS] is in a range of from about 300 to about 400.

In one non-limiting embodiment, the methyl cellulose has a degree of substitution of methyl group (MeDS) greater than 1.40.

The rheology modifier can be hydrophobically modified cellulose ether. The hydrophobically modified cellulose ether can be obtained from modification with a hydrophobic substitution group. The hydrophobic substitution group can be a straight or branched alkyl or alkenyl group of from 1 to about 24 carbons. In one non-limiting embodiment, the hydrophobic substitution can be a straight or branched alkyl or alkenyl group of from about 3 to about 15 carbons. The hydrophobic substitution group can also be arylalkyl residues with C₇ to C₁₅ carbon atoms.

In one non-limiting embodiment, the hydrophobic substitution group can be derived from an alkyl radical selected from the group consisting of linear or branched butyl radicals, linear or branched dodecyl radicals, linear or branched hexadecyl radicals, and linear or branched docosyl radicals. More particularly, such alkyl radicals can be selected from the group consisting of linear or branched butylhalide, linear or branched butyl glycidylether, linear or branched dodecylhalide, linear or branched dodecyl glycidylether, linear or branched hexadecylhalide, linear or branched hexadocyl glycidylether, linear or branched docosylhalide, and linear or branched docosyl glycidylether.

Examples of the hydrophobically modified cellulose ether can include, but are not limited to, hydrophobically modified carboxymethyl cellulose (HMCMC), hydrophobically modified hydroxyethyl cellulose (HMHEC), hydrophobically modified hydroxypropyl cellulose (HMHPC), hydrophobically modified ethyl hydroxyethyl cellulose (HMEHEC), hydrophobically modified carboxymethyl hydroxyethyl cellulose (HMCMHEC), hydrophobically modified hydroxypropylhydroxyethyl cellulose (HMHPHEC), hydrophobically modified methyl cellulose (HMMC), hydrophobically modified methyl hydroxypropyl cellulose (HMMHPC), hydrophobically modified methyl hydroxyethyl cellulose (HMMHEC), hydrophobically modified carboxymethylmethyl cellulose (HMCMMC).

Methods for producing hydrophobically modified hydroxyethyl cellulose by reacting cellulose ether with alkylglycidyl ethers where the alkyl group contains from 1 to 10 carbon atoms are disclosed in U.S. Pat. No. 4,939,192. Methods for producing hydrophobically modified nonionic water-soluble cellulose ethers by substitution with hydrocarbon radicals having from about 10 to 24 carbon atoms are disclosed in U.S. Pat. No. 4,228,277. Water-soluble cellulose ethers which are modified with C₁₀ to C₂₄ long chain alkylaryl groups are disclosed by Just et al. in U.S. Pat. No. Re. 34,904, a reissue of U.S. Pat. No. 5,120,838. The disclosures of these patents include cellulose ethers with spacer groups of various lengths between the alkylaryl group and the connecting group to the cellulose molecule. Hydroxyethyl cellulose and hydroxypropyl cellulose hydrophobically modified with a perfluorinated alkyl hydrophobe glycidyl ether are disclosed by Angerer et al. in U.S. Pat. No. 5,290,829. The entire contents of all of these are hereby expressly incorporated herein by references.

The rheology modifier in the presently disclosed and/claimed inventive concept(s) can further comprise synthetic associative thickener (SAT) rheology modifiers in addition to cellulose ethers. In one non-limiting embodiment, the SAT rheology modifiers can be nonionic synthetic associative thickeners (NSATs) and hydrophobically modified alkali-swellable and alkali-soluble emulsion (HASE) polymers.

Typical NSATs can include, but are not limited to, polyacetal-polyether (PAPE), hydrophobically-modified ethoxylated urethane (HEUR), hydrophobically-modified polyethylene glycol (HMPEG), and hydrophobically-modified polyacetal-polyether (HMPAPE) that have enjoyed widespread use in waterborne paint formulas due to their ability to provide superior rheological characteristics such as spatter and sag resistance, leveling, and brush flow. These materials are usually manufactured at the production facility, added to water as molten solids to dissolve and then shipped to customers as aqueous solutions. The active solid contents of these solutions generally range from 17 to 30 wt %.

Typical HASE polymers are free radical addition polymers polymerized from pH sensitive or hydrophilic monomers (e.g., acrylic acid and/or methacrylic acid), hydrophobic monomers (e.g., C₁-C₃₀ alkyl esters of acrylic acid and/or methacrylic acid, acrylonitrile, styrene), an “associative monomer”, and an optional crosslinking monomer. The associative monomer comprises an ethylenically unsaturated polymerizable end group, a non-ionic hydrophilic midsection that is terminated by a hydrophobic end group. The non-ionic hydrophilic midsection comprises a polyoxyalkylene group, e.g., polyethylene oxide, polypropylene oxide, or mixtures of polyethylene oxide/polypropylene oxide segments. The terminal hydrophobic end group is typically a C₈-C₄₀ aliphatic moiety. Exemplary aliphatic moieties are selected from linear and branched alkyl substituents, linear and branched alkenyl substituents, carbocyclic substituents, aryl substituents, aralkyl substituents, arylalkyl substituents, and alkylaryl substituents. In one aspect, associative monomers can be prepared by the condensation (e.g., esterification or etherification) of a polyethoxylated and/or polypropoxylated aliphatic alcohol (typically containing a branched or unbranched C₈-C₄₀ aliphatic moiety) with an ethylenically unsaturated monomer containing a carboxylic acid group (e.g., acrylic acid, methacrylic acid), an unsaturated cyclic anhydride monomer (e.g., maleic anhydride, itaconic anhydride, citraconic anhydride), a monoethylenically unsaturated monoisocyanate (e.g., α,α-dimethyl-m-isopropenyl benzyl isocyanate) or an ethylenically unsaturated monomer containing a hydroxyl group (e.g., vinyl alcohol, allyl alcohol). Polyethoxylated and/or polypropoxylated aliphatic alcohols are ethylene oxide and/or propylene oxide adducts of a monoalcohol containing the C₈-C₄₀ aliphatic moiety. Non-limiting examples of alcohols containing a C₈-C₄₀ aliphatic moiety are capryl alcohol, iso-octyl alcohol (2-ethyl hexanol), pelargonic alcohol (1-nonanol), decyl alcohol, lauryl alcohol, myristyl alcohol, cetyl alcohol, cetyl alcohol, cetearyl alcohol (mixture of C₁₆-C₁₈ monoalcohols), stearyl alcohol, isostearyl alcohol, elaidyl alcohol, oleyl alcohol, arachidyl alcohol, behenyl alcohol, lignoceryl alcohol, ceryl alcohol, montanyl alcohol, melissyl, lacceryl alcohol, geddyl alcohol, and C₂-C₂₀ alkyl substituted phenols (e.g., nonyl phenol), and the like.

Exemplary HASE polymers are disclosed in U.S. Pat. Nos. 3,657,175; 4,384,096; 4,464,524; 4,801,671; and 5,292,843, which are herein incorporated by reference. In addition, an extensive review of HASE polymers is found in Gregory D. Shay, Chapter 25, “Alkali-Swellable and Alkali-Soluble Thickener Technology A Review”, Polymers in Aqueous Media-Performance Through Association, Advances in Chemistry Series 223, J. Edward Glass (ed.), ACS, pp. 457-494, Division Polymeric Materials, Washington, D.C. (1989), the relevant disclosures of which are incorporated herein by reference. The HASE polymers are commercially available from The Dow Chemical Company under the trade designations Aculyn® 22 (INCI Name: Acrylates/Steareth-20 Methacrylate Copolymer), Aculyn® 44 (INCI Name: PEG-150/Decyl Alcohol/SMDI Copolymer), Aculyn 46® (INCI Name: PEG-150/Stearyl Alcohol/SMDI Copolymer), and Aculyn® 88 (INCI Name: Acrylates/Steareth-20 Methacrylate Crosspolymer). A commercial product from The Dow Chemical Company, Acrysol® TT-935, has proved particularly effective in the presently disclosed and/or claimed inventive concept(s).

The amount of rheology modifier used in the composition A is not narrowly critical. In the broadest sense, the amount of rheology modifier used is sufficient to provide the desired thickening and rheological properties to the composition A. Typically, the amount of theology modifier used can be controlled to obtain the Stormer viscosity of about 80-85 KU in the composition A. The abbreviation KU, which refers to the low shear viscosity, stands for the Stormer viscosity measurement which is expressed in Krebs Units (KU) and is determined according to ASTM D662-81.

In one non-limiting embodiment, the amount of rheology modifier is at least about 0.05 wt %. In another non-limiting embodiment, the amount of rheology modifier is from about 0.15 wt % to 3 wt %. In yet another non-limiting embodiment, the amount of rheology modifier is from about 0.25 wt % to 1.5 wt %.

Biocides are typically included in latex paints to provide the paint with resistance to microorganisms. Biocides may be incorporated at different stages of the paint manufacture process; however, they are commonly added in the last steps to decrease their exposure to high temperature or potential deactivating reagents.

In this context the term “biocide” means any compound that is active against a biological entity, which may otherwise damage or degrade a wood substrate or a component in a coating composition or coating film. The biocide may actively kill the biological entity (so that the activity can be said to be “biocidal”) or the biocide may prevent the growth of the biological entity (so that the activity can be said to be “biostatic”). The biocidal or biostatic activity may be directed against any biological entity capable of degrading a wood substrate or a component of a coating composition or coating film, i.e. the biological entity may be a fungus, such as a basidiomycete, an ascomycete, a mold or a filamentous fungus, an alga, a bacterium, an insect etc. In one non-limiting embodiment, the biocide can be methyl chloroisothiazolinone.

Any other biocides can be used in the presently disclosed and/or claimed inventive concept(s). For example, but by no way of limitation, fungicides, such as tolylfluanid, N-cyclopropyl-N′—(I,I-dimethylethyl)-6-(methylthio)-1,3,5-triazine-2,4-diamine, tetrachloroisophthalonitrile, N-(trichloromethylthio)phthalimide, propiconazol, tebuconazol, octyl-isothiazolinone, dichlor-isothiazolinone or quat; algaecides, such as ter-bythryn or zinkpyrothione; insecticides, such as fipronil, thiamethoxam, chlorfenapyr or thiachloprid; and bactericides.

In addition, commercially available biocides can also be used in the presently disclosed and/or claimed inventive concept(s). Examples can include, but are not limited to, Kathon™ LXE, Kathon™ LX, Rocima™ KO and Dowicil™ 75, which are available from The Dow Chemical Company. Polyphase® AF3 and Polyphase® PW40 are available from Troy Corporation. Acticide® OTW is available from Thor Group Limited. Proxel™ BD-20 is available from Arch Chemicals Inc.

Neutralizing agents are present in many waterborne coatings, such as latex paint, in order to bring the pH up to an optimal value between about 8 and about 10, typically about 8.5 to about 9.3. Hydroxides such as sodium hydroxide, potassium hydroxide, and calcium hydroxide; ammonia and various low molecular weight aliphatic amines can be used in the presently disclosed and/or claimed inventive concept(s). In one non-limiting embodiment, the neutralizing agent can be selected from the group consisting of 2-amino-2-methyl-1-propanol, monoethaolamine, methylaminoethanol, and combinations thereof.

N-alkyldialkanolamines or N-isoalkyldialkanolamines with 4 to 8 carbon atoms can also be used as neutralizing agents in the presently disclosed and/or claimed inventive concept(s). Exemplary N-alkyldialkanolamines can include, but are not limited to, N-butyldiethanolamine, N-pentyldiethanolamine, N-hexyldiethanolamine, N-heptyldiethanolamine, N-octyldiethanolamine, N-butyldipropanolamine, N-pentyldipropanolamine, N-hexyldipropanolamine, N-heptyldipropanolamine, and N-octyldipropanolamine. Such N-alkyldialkanolamines have low odor, excellent assistance to pigment dispersion, excellent assistance to water resistance, excellent corrosion inhibition, excellent leveling characteristics and emulsification properties.

The solvent can be water or any aqueous solution.

Coalescing agents are high boiling point solvents (that are slow to evaporate) used to reduce the minimum film formation temperature (MFFT) of paints, inks, other coating compositions and the like. In paint formulations in particular, coalescing agents act as temporary plasticizers to reduce the glass transition temperature (T_{g}) of the latex below the drying temperature to allow good film formation. Generally, coalescing agents function by softening the polymer particles in latex, enabling the formation of a continuous film as the coating cures.

0.1-10 wt % coalescing agent based on the total weight of the composition A can be used to aid in the formation of a continuous film as the stone paint cures. Suitable coalescing agents can include, but are not limited to, ethylene glycol, propylene glycol, hexylene glycol, 2,2,4-trimethyl-1,3-pentanediol monoisobutyrate, Coasol™ (available from The Dow Chemical Company), glycol ethers, mineral spirits, methylcarbitol, butylcarbitol, phthalates, and adipates.

In one non-limiting embodiment, 2,2,4-trimethyl-1,3-pentanediol monoisobutyrate can be used as a coalescing agent, which is available as Texanol™ from Eastman Chemical Company.

Low- or zero-VOC coalescing agents can also be used in the presently disclosed and/or claimed inventive concept(s). Examples of low- or zero-VOC coalescing agents can include, but are not limited to, dicarboxylic/tricarboxylic esters, such as bis(2-ethylhexyl) phthalate (DEHP), diusononyl phthalate (DINP), bis(n-butyl)phthalate (DnBP, DBP), butyl benzyl phthalate (BBzP), diisodecyl phthalate (DIDP), di-n-octyl phthalate (DOP or DnOP), diisooctyl phthalate (DIOP), diethyl phthalate (DEP), diusobutyl phthalate (DIBP), di-n-hexyl phthalate, trimethyl trimellitate (TMTM), tri-(2-ethylhexyl) trimellitate (TEHTM-MG), tri-(n-octyl,n-decyl) trimellitate (ATM), tri-(heptyl,nonyl) trimellitate (LTM) and n-octyl trimellitate (OTM); adipates, such as bis(2-ethylhexyl)adipate (DEHA), dimethyl adipate (DMAD), monomethyl adipate (MMAD) and dioctyl adipate (DOA); sebacates, such as dibutyl sebacate (DBS); maleates such as dibutyl maleate (DBM) and diisobutyl maleate (DIBM). Other low- or zero-VOC coalescing agents include benzoates, epoxidized vegetable oils, such as N-ethyl toluene sulfonamide, N-(2-hydroxypropyl) benzene sulfonamide and N-(n-butyl) benzene sulfonamide; organophosphates, such as tricresyl phosphate (TCP) and tributyl phosphate (TBP), triethylene glycol dihexanoate, tetraethylene glycol diheptanoate, and polymeric plasticizers. Examples of commercial low- and zero-VOC coalescing agents are benzoate esters or alkyl benzoate esters, such as those sold under Benzoflex™ and Velate™, and low molecular weight polyesters, such as those sold under Admex™, which are all available from Eastman Chemical Company.

The sand in the composition B can be any types of sands used in the stone paint, including but not limited to, natural sands, machine made sands and combinations thereof. Examples can include, but are not limited to, color sands, stone sands, and quartz sands. In addition to natural sands, the machine made sands can also combined with river gravels, industrial waste, construction wastes, mining wastes, and combinations thereof.

The stone paint formulation further comprises a pigment. In one non-limiting embodiment, the pigment is selected from the group consisting of hydrated aluminum oxide, barium sulfate, calcium silicate, lay, silica, talc, titanium dioxide, zinc oxide, magnesium aluminum silicate, and mixtures thereof. Oftentimes, titanium dioxide grades used in the aqueous protective coating composition are surface modified with various inorganic oxides, such as silicates, aluminates, and zirconates. Aluminum silicate, nepeline syenite, mica, calcium carbonate, and/or diatomaceous earth can also be employed.

For colored stone paint, desired colorants can be added to the stone paint formulations. The colorants can be synthetic organic pigments and/or inorganic compounds such as metallic oxides, including but not limited to iron oxide and/or chromium oxide. Carbon black can also be used as a colorant to tailor the color of a coating.

In addition, the stone paint formulation may contain other functional additives, for example, but not by way of limitation, defoamers (e.g., nonsilicone and silicone types), surfactants, preservatives, plasticizers, stabilizers, viscosifiers, leveling aids, anti-skinning agents, extenders, cross-linkers, corrosion inhibitors, surface improvers, matting agents, humectants/wet-edge agents (e.g., ethylene glycol, propylene glycol, and hexylene glycol), pH and modifiers, etc.

The presently disclosed and/or claimed inventive concept(s) also relates to a method for manufacturing a stone paint formulation, comprising the steps of:
(a) preparing a solution containing a rheology modifier and a solvent,
(b) adding the solution to a mixture containing a latex emulsion and a coalescing agent and mixing to form a base paint,
(c) adjusting the pH of the base paint using a neutralizing agent, and
(d) adding a biocide to the base paint to form the stone paint formulation.

The rheology modifier, the solvent, the latex emulsion, the coalescing agent, the neutralizing agent and the biocide are the same as those described previously.

A method for preparing a stone paint according to the presently disclosed and/or claimed inventive step(s), comprising adding a sand to the stone paint formulation described above. The weight ratio of the stone paint formulation to the sand is from about 20:80 to about 50:50. In one non-limiting embodiment, the weight ratio of the stone paint formulation to the sand is about 30:70 to about 40:60. The particle size of the sand can be varied from about 0.05 mm to about 1.0 mm. In a non-limiting embodiment, the particle size of the sand can be varied from 0.1 mm to 0.9 mm.

The following examples illustrate the presently disclosed and/or claimed inventive concept(s), parts and percentages being by weight, unless otherwise indicated. Each example is provided by way of explanation of the presently disclosed and/or claimed inventive concept(s), not limitation of the presently disclosed and/or claimed inventive concept(s). In fact, it will be apparent to those skilled in the art that various modifications and variations can be made in the presently disclosed and/or claimed inventive concept(s) without departing from the scope or spirit of the invention. For instance, features illustrated or described as part of one embodiment, can be used on another embodiment to yield a still further embodiment. Thus, it is intended that the presently disclosed and/or claimed inventive concept(s) covers such modifications and variations as come within the scope of the appended claims and their equivalents.

### EXAMPLES

### Measurements of Cellulose Ethers

The cellulose ether prepared was analyzed with regard to the degree of substitution (DS) of methyl and to the molecular substitutions (MS) of hydroxyethyl and hydroxypropyl by ¹H-NMR described below.

### ¹H-NMR Method:

Samples of cellulose ether were acid hydrolyzed prior to the NMR measurement.

Sample Hydrolysis:

25 mg of cellulose ether sample was initially swelled in 0.75 gm of D₂O. To the swelled sample, 1.5 gm 3M trifluroacetic acid (TFA) in D₂O was added. The solution vial was maintained at 100° C. for 5 hours. Sample vial was cooled for 15 minutes before 0.3 gm of D₂SO₄ was added. Sample solution was maintained at 100° C. for one additional hour. The sample solution was allowed to cool down (˜30 mins) and transferred to 5 mm NMR tube for analysis.

NMR Measurement:

Quantitative ¹H NMR spectrum was recorded using Bruker 400 MHz NMR spectrometer. Acquisition parameters were as follows: temperature 300K, sweep width 20 ppm, pulse width 45 deg, number of scans 128, relaxation delay 30 s. Processing parameters were as follows: line broadening 0.3 Hz.

Spectrum was phase and baseline corrected using standard practice. Center of the most down-field doublet in the anomeric region (4.32-5.43 ppm) was referenced to 5.231 ppm. The spectrum was integrated as follows:

Region A (I_{A})=4.32-5.43 ppm (integral area was calibrated to a value of 1.0, other integral areas were relative to this integral value);
Region B (I_{B})=2.70-4.32 ppm;

### Region C (I_{C})=2.865-2.95 ppm (for MHEC);

Region D (I_{D})=4.92-5.32 ppm;
Region E (I_{E})=5.00-5.028 ppm; and

### Region F (I_{F})=0.70-1.20 ppm (for MHPC).

DS/MS and % unsubstituted anhydroglucose (% unsub AGU) are calculated as follows:

### For MHEC:

HE MS=I_{C}*k

(where k is 6.6489, empirical scaling factor);

Methyl DS=(I_{B}−(4*HE MS)−(I_{A}*6))/(3*I_{A});

and

% unsub AGU=(I_{E}/I_{D})*Methyl DS*100.

### For MC:

Methyl DS=(I_{B}−(I_{A}*6))/(3*I_{A});

and

% unsub AGU=(I_{E}/I_{D})*Methyl DS*100.

### For MHPC:

Methyl DS=(I_{B}−I_{F}−(I_{A}*6))/(3*I_{A});

HP MS=I_{F}/(3*I_{A});

and

% unsub AGU=(I_{E}/I_{D})*Methyl DS*100.

The viscosity of a 2 wt % of methyl cellulose was measured by a Brookfield visco-meter, type RV, at a temperature of 20° C. The viscosities of a 2 wt % of methyl hydroxyethyl cellulose and a 2 wt % of methyl hydroxypropyl cellulose were measured by a Brookfield visco-meter, type RV or LV, at a temperature of 20° C.

As used herein, the term “molecular weight” means weight average molecular weight. Methods for determining weight average molecular weight of cellulose ethers are known to those skilled in the art.

### Preparation of Cellulose Ethers

### Example 1—Preparation of MHPC (A2)—High Solid Process

MHPC sample A2 was prepared as follows:

a) 135 g of ground cellulose was charged to a 2.5 L horizontal high-solid reactor equipped with a horizontally-mounted plow-type agitator. The air was carefully replaced with nitrogen, followed by nitrogen pressurization to 300 psig. Vacuum was applied to the reactor to provide 25 inches of reduced pressure. The reduced pressure was held for 1 minute. The reactor was then pressurized to 25 psig with nitrogen. Vacuum purging followed by nitrogen pressurization was repeated twice. For nitrogen/vacuum cycles, the agitator was off. For the 1 minute hold between nitrogen and vacuum cycles agitation was applied at 30 rpm. Finally, 24 inches of vacuum was applied and vacuum shut off.
b) Under agitation, 383 g of 50% sodium hydroxide was added at ambient temperature over 20 minutes.
c) 202.2 g of dimethyl ether was added at ambient temperature over 10 minutes.
d) 91 g of methyl chloride and 58.2 g of propylene oxide were added over 5 minutes each at ambient temperature.
e) The temperature was raised to about 95° C. over about 80 minutes and maintained at this level for about 60 minutes.
f) The reactor was cooled to 50° C.
g) 252.2 g of methyl chloride was added over 10 minutes.
h) The temperature was raised to 95° C. at 1° C./min and maintained at this level for 90 minutes.
i) The reactor was then cooled to below 40° C. During cooling the reactor was also vented to atmospheric pressure. Vacuum was then applied to provide 28 inches of reduced pressure. The reduced pressure was held for 1 minute. The reactor was then pressurized to 5 psig with nitrogen. Vacuum purging followed by nitrogen pressurization was repeated 3 times. The reactor was vented to atmospheric pressure and the contents removed. A wet cake was obtained. The wet cake was subjected to a series of hot water washes while adjusting to neutral pH. After drying and milling a methyl hydroxypropyl cellulose was obtained.

### Example 2—Preparation of MHPC (A3-A5)—High Solid Process

MHPC samples A3-A5 were prepared as follows:

a) Ground cellulose was charged to a 2.5 L horizontal high-solid reactor equipped with a horizontally-mounted plow-type agitator. The air was carefully replaced with nitrogen, followed by nitrogen pressurization to 300 psig. Vacuum was applied to the reactor to provide 25 inches of reduced pressure. The reduced pressure was held for 1 minute. The reactor was then pressurized to 25 psig with nitrogen. Vacuum purging followed by nitrogen pressurization was repeated twice. For nitrogen/vacuum cycles, the agitator was off. For the 1 minute hold between nitrogen and vacuum cycles agitation was applied at 30 rpm. Finally, 24 inches of vacuum was applied and vacuum shut off.
b) Under agitation, 50% sodium hydroxide was added at ambient temperature over 20 minutes.
c) Dimethyl ether was added at ambient temperature over 10 minutes.
d) Methyl chloride and propylene oxide were added over 5 minutes each at ambient temperature.
e) The temperature was raised to about 65° C. for A5 and to about 95° C. for A3 and A4 at 1° C./minute and maintained at this level for about 30 minutes.
f) The reactor was cooled until the pressure was less than 100 psig.
g) Methyl chloride was added over 10 minutes.
h) The temperature was raised to 95° C. at 1° C./min and maintained at this level for about 60 minutes.
i) The reactor was then cooled to below 40° C. During cooling the reactor was also vented to atmospheric pressure. Vacuum was then applied to provide 28 inches of reduced pressure. The reduced pressure was held for 1 minute. The reactor was then pressurized to 5 psig with nitrogen. Vacuum purging followed by nitrogen pressurization was repeated 3 times. The reactor was vented to atmospheric pressure and the contents removed. A wet cake was obtained. The wet cake was subjected to a series of hot water washes while adjusting to neutral pH. After drying and milling a methyl hydroxypropyl cellulose was obtained.

Reagent quantities and reaction conditions used in the preparation of samples A3-A5 are shown in Table 1 below.

TABLE 1

| | | 50% | MeCl | MeCl | | |
|---|---|---|---|---|---|---|
| | Cellulose | NaOH | at step d) | at step g) | DME | PO |
| Sample | gram | gram | gram | gram | gram | gram |
| A3 | 150 | 420.6 | 81 | 259.8 | 232.0 | 64.9 |
| A4 | 150 | 430.4 | 90.1 | 259.8 | 234.3 | 65.0 |
| A5 | 150 | 293.2 | 238.1 | 0 | 151.0 | 67.1 |

### Example 3—Preparation of MHPC in Slurry Process

The MHEC slurry samples A6-A7, A9, and A11-A20 were prepared as follows:

a) A slurry mixture of ground cellulose pulp and heptane was charged to a vertical reactor. The air was carefully replaced by nitrogen followed by nitrogen pressurization to 105 psig. Vacuum was applied to the system to provide 28 inches of reduced pressure. The reduced pressure was maintained for 1 minute. Pressurization followed by vacuum purging was repeated. The reactor was then pressurized to 15 psig with nitrogen.
b) Under agitation, a quantity of 50% aqueous sodium hydroxide was charged to the reactor at 18° C. Vacuum was applied to the reactor to provide 28 inches of reduced pressure. The reduced pressure was maintained for 1 minute. The reactor was pressurized to 15 psig with nitrogen. Vacuum purging followed by pressurization to 15 psig was repeated 4 more times.
c) Propylene oxide was then charged, followed by methyl chloride.
d) The temperature was raised to 60° C. over 50 minutes and maintained at this level for 30 minutes.
e) The temperature was raised to 90° C. over 30 minutes and maintained at this level for 60 minutes.
f) The temperature was raised to 105° C. over 30 minutes and maintained at this level for 120 minutes.
g) The reactor was cooled to 40° C. The content of the reactor was filtered and a wet cake was obtained. The wet cake was subjected to a series of hot water washes while adjusting to neutral pH. After drying and milling a methyl hydroxypropyl cellulose was obtained.

Reagent quantities and reaction conditions used in the preparation of Samples A6-A7, A9 and A11-A20 are shown in Table 2 below.

TABLE 2

| Sample | Cellulose, g | Heptane, g | 50% NaOH, g | PO, g | MeCl, g |
|---|---|---|---|---|---|
| A6 | 75.7 | 679.0 | 118.1 | 19.8 | 64.0 |
| A7 | 75.7 | 679.0 | 121.8 | 20.7 | 65.9 |
| A9 | 75.7 | 679.0 | 130.6 | 24.8 | 69.6 |
| A11 | 68.9 | 658.5 | 96.9 | 10.8 | 51.0 |
| A12 | 68.9 | 658.5 | 96.9 | 9.1 | 50.7 |
| A13 | 68.9 | 658.5 | 97.6 | 11.0 | 51.0 |
| A14 | 68.9 | 658.5 | 96.8 | 9.2 | 51.8 |
| A15 | 68.9 | 658.5 | 97.4 | 10.4 | 51.4 |
| A16 | 68.9 | 658.5 | 97.5 | 10.8 | 51.4 |
| A17 | 75.7 | 679.0 | 129.8 | 31.7 | 70.0 |
| A18 | 75.7 | 679.0 | 133.5 | 30.5 | 71.9 |
| A19 | 75.7 | 679.0 | 138.8 | 31.9 | 75.2 |
| A20 | 75.7 | 679.0 | 145.7 | 31.8 | 78.9 |

### Example 4—Preparation of MHEC in Slurry Process

The MHEC slurry samples B1-B4 and B7-B8 were prepared as follows:

a) A slurry mixture of ground cellulose pulp and heptane was charged to a vertical reactor. The air was carefully replaced by nitrogen followed by nitrogen pressurization to 105 psig. Vacuum was applied to the reactor to provide 28 inches of reduced pressure. The reduced pressure was maintained for 1 minute. Pressurization followed by vacuum purging was repeated. The reactor was then pressurized to 15 psig with nitrogen.
b) Under agitation, a quantity of 50% aqueous sodium hydroxide was charged to the reactor at 18° C. Vacuum was applied to the system to provide 28 inches of reduced pressure. The reduced pressure was maintained for 1 minute. The reactor was pressurized to 15 psig with nitrogen. Vacuum purging followed by pressurization to 15 psig was repeated 4 more times.
c) Ethylene oxide was then charged.
d) Methyl chloride was charged to the reactor.
e) The temperature was raised to 60° C. over 50 minutes and maintained at this level for 30 minutes.
f) The temperature was raised to 90° C. over 30 minutes and maintained at this level for 60 minutes.
g) The temperature was raised to 105° C. over 30 minutes and maintained at this level for 120 minutes.
h) The reactor was cooled to 40° C. The content of the reactor was filtered and a wet cake was obtained. The wet cake was subjected to a series of hot water washes while adjusting to neutral pH. After drying and milling a methyl hydroxyethyl cellulose was obtained.

Reagent quantities and reaction conditions used in the preparation of Samples B1-B4 and B7-B8 are shown in Table 3 below.

TABLE 3

| Sample | Cellulose, g | Heptane, g | 50% NaOH, g | EO, g | MeCl, g |
|---|---|---|---|---|---|
| B1 | 73.5 | 658.5 | 168.3 | 2.7 | 99.7 |
| B2 | 73.5 | 658.5 | 170.8 | 0.6 | 100.2 |
| B3 | 73.5 | 658.5 | 136.7 | 0.4 | 80.0 |
| B4 | 40.4 | 362.2 | 78.1 | 1.4 | 45.9 |
| B7 | 40.4 | 362.2 | 94.0 | 1.4 | 55.0 |
| B8 | 66.1 | 592.7 | 179.0 | 5.0 | 105.5 |

### Example 5—Preparation of MHEC—High Solid Process

The MHEC samples B5-B6 with high solids were prepared as follows:

a) Ground cellulose was charged to a 2.5 L horizontal high-solids reactor equipped with a horizontally-mounted plow-type agitator. The air was replaced with nitrogen, followed by nitrogen pressurization to 300 psig. Vacuum was applied to the reactor to provide 28 inches of reduced pressure. The reduced pressure was held for 1 minute. The reactor was then pressurized to 20 psig with nitrogen. Vacuum purging followed by nitrogen pressurization was repeated.
b) Under agitation and with the reactor at 25° C., dimethyl ether was charged over 5 minutes.
c) Methyl chloride was added over 10 minutes.
d) Dimethyl ether was charged to the reactor over 5 minutes.
e) 50% aqueous sodium hydroxide was charged to the reactor over 5 minutes.
f) Ethylene oxide was charged to the reactor under nitrogen.
g) The reactor was then heated up to 85° C.
h) 50% aqueous sodium hydroxide was added over 5 minutes.
i) The reactor was then heated up to 95° C. and held for 60 minutes.
j) The reactor was cooled and decompressed down to atmospheric pressure and at approximately 40° C. The reactor was then evacuated and pressurized to approximately 20 psig with nitrogen 3 times. The resulting wet cake was subjected to a series of hot water washes while adjusting to neutral pH. After drying and grinding a methyl hydroxyethyl cellulose was obtained.

Reagent quantities and reaction conditions used in the pre aratgin of samples B5 and B6 are shown in Table 4 below.

TABLE 4

| | | | 50% | 50% | | | |
|---|---|---|---|---|---|---|---|
| | | | NaOH | NaOH | DME | DME | |
| | | | at step | at step | at step | at step | |
| | Cellulose | MeCl | (e) | (h) | (b) | (d) | EO |
| Sample | g | g | g | g | g | g | g |
| B5 | 150.0 | 264.2 | 225.6 | 85.2 | 86.8 | 86.1 | 19.0 |
| B6 | 140.1 | 277.5 | 267.0 | 94.2 | 83.5 | 80.2 | 15.0 |

### Example 6—Preparation of MC in Slurry Process

The MC slurry samples C1-C14 and C18 were prepared as follows:

a) A slurry mixture of ground cellulose pulp and heptane was charged to a vertical reactor. The air was carefully replaced by nitrogen followed by nitrogen pressurization to 105 psig. Vacuum was applied to the reactor to provide 28 inches of reduced pressure. The reduced pressure was maintained for 1 minute. Pressurization followed by vacuum purging was repeated. The reactor was then pressurized to 15 psig with nitrogen.
b) Under agitation, a quantity of 50% aqueous sodium hydroxide was charged to the reactor at 18° C. Vacuum was applied to the reactor to provide 28 inches of reduced pressure. The reduced pressure was maintained for 1 minute. The reactor was pressurized to 15 psig with nitrogen. Vacuum purging followed by pressurization to 15 psig was repeated 4 more times.
c) Methyl chloride was then charged.
d) The temperature was raised to a certain level and maintained at the level for a certain period of time.
e) The reactor was cooled to 40° C. The content of the reactor was filtered and a wet cake was obtained. The wet cake was subjected to a series of hot water washes while adjusting to neutral pH. After drying and milling a methylhydroxyethyl cellulose was obtained.

Reagent quantities and reaction conditions used in the preparation of Samples C1-C14 and C18 are shown in Table 5 below.

TABLE 5

| | | | | | Temp. | Time for |
|---|---|---|---|---|---|---|
| | | | 50% | | Hold at | hold |
| | Cellulose | Heptane | NaOH | MeCl | step d), | at step d), |
| Sample | g | g | g | g | ° C. | h |
| C1 | 73.5 | 658.5 | 131.7 | 77.9 | 105 | 1 |
| C2 | 73.5 | 658.5 | 177.8 | 104.1 | 105 | 2 |
| C3 | 73.5 | 658.5 | 177.8 | 104.1 | 105 | 2 |
| C4 | 73.5 | 658.5 | 168.2 | 99.1 | 105 | 2 |
| C5 | 73.5 | 658.5 | 131.9 | 76.8 | 87 | 1 |
| C6 | 73.5 | 658.5 | 177.7 | 104.5 | 105 | 2 |
| C7 | 73.5 | 659.0 | 176.8 | 104.0 | 105 | 2 |
| C8 | 73.5 | 659.0 | 196.3 | 115.2 | 105 | 2 |
| C9 | 73.5 | 658.5 | 177.7 | 104.5 | 105 | 2 |
| C10 | 73.5 | 658.5 | 177.7 | 104.1 | 105 | 2 |
| C11 | 73.5 | 658.5 | 131.5 | 77.1 | 75 | 1 |
| C12 | 73.5 | 658.5 | 131.7 | 76.9 | 83 | 1 |
| C13 | 40.5 | 362.2 | 72.1 | 42.3 | 105 | 1 |
| C14 | 91.9 | 658.5 | 178.2 | 104.6 | 105 | 2 |
| C18 | 73.5 | 658.5 | 178.1 | 104.4 | 105 | 2 |

### Example 7—Preparation of MC Sample C15 in High-Solid Process

The MC sample C15 with high solids was prepared as follows:

a) 150 g of ground cellulose was charged to a 2.5 L horizontal high-solid reactor equipped with a horizontally-mounted plow-type agitator. The air was carefully replaced with nitrogen, followed by nitrogen pressurization to 300 psig. Vacuum was applied to the reactor to provide 28 inches of reduced pressure. The reduced pressure was held for 1 minute. The reactor was then pressurized to 20 psig with nitrogen. Vacuum purging followed by nitrogen pressurization was repeated.
b) Under agitation, with the reactor at 25° C., 96.1 g of dimethyl ether was charged to the reactor over 5 minutes.
c) 284.6 g of methyl chloride was charged to the reactor over 10 minutes.
d) 96.6 g of dimethyl ether was charged to the reactor over 5 minutes.
e) 371 g of 50% aqueous sodium hydroxide was charged to the reactor over 15 minutes.
f) The temperature was raised to 95° C. and maintained at this level for 1 hour.
g) The reactor was cooled to 25° C. and vented down to atmospheric pressure. Vacuum was applied to provide 28 inches of reduced pressure. The reduced pressure was held for one minute. The reactor was then pressurized to 5 psig with nitrogen. Vacuum purging followed by nitrogen pressurization was repeated 3 times. The reactor was vented to atmospheric pressure and the contents removed. A wet cake was obtained. The wet cake was subjected to a series of hot water washes while adjusting to neutral pH. After drying and milling a methylcellulose was obtained.

### Preparation of Base Paint Formulation Having Cellulose Ethers and Test for Water Whitening

Water whitening performance of the base paint formulation was evaluated based on the coating film prepared from a mixture comprising a latex emulsion, a rheology modifier, a coalescing agent, a biocide, a neutralizing agent and a solvent.

An aqueous solution of cellulose ether was prepared using the procedures known in the art. This solution was added to a mixture of 48 g of RS-991 (commercially available from BATF Industrial Co. Ltd., Fushan, Guangdong, China) and 1.6 g of Texanol™ (commercially available from Eastman Chemical Company, Kingsport, Tenn., USA) and mixed for 1 hr to form a base paint. The pH of the base paint was adjusted by addition of few drops of AMP-95™ (commercially available from The Dow Chemical Company, USA) to 8.5-9.0 and about 0.4 g of Kathon™ LXE (commercially available from The Dow Chemical Company, USA) was added to form a base paint formulation. Drawdowns of the base paint formulation were cast on a clear polyester substrate using a 6 mil (150 micron) gap applicator. These drawdowns are hereby referred to as base paint panels. The wet film thickness of the applied base paint panel was about 3 mil. The panels were then dried overnight for 16-24 hours under controlled temperature (50° C.) and humidity (35-50%). The panels were subjected to a water whitening test by soaking, which is described below.

The dried base paint panels were submerged in a water bath (23-25° C.). The films typically turn white/opaque within 5-20 minutes of contact with water. The water whitening of the panel was assessed by assigning a rating listed in Table 6 after soaking the panel in water for 4 hours.

TABLE 6

| Rating | Description |
|---|---|
| 5 | Completely transparent |
| 4 | Slight whitening |
| 3 | Moderate whitening |
| 2 | Severe whitening |
| 1 | Opaque |

Table 7 shows the experimental results of using MHPC as a rheology modifier in the base paint formulation.

TABLE 7

| | | | | Water | | | |
|---|---|---|---|---|---|---|---|
| | | | NMR % | Whitening | | Viscosity, Pa · S | |
| | MHPC | MeDS/HpMS + | Unsub | Latex | | (RV spindle #6 | |
| MHPC | wt % | 180*MeDS | AGU | (25° C.) | | or #5 or #4) | SEC MW |
| A2 | 0.57 | 385.24 | 4.05 | 4− | @65.2 KU | — | 331000 |
| A3 | 0.60 | 391.59 | 5.13 | 4− | @81.6 KU | 33500 (#6) | 1030000 |
| A4 | 0.60 | 392.33 | 4.70 | 3+ | @80.0 KU | 12200 (#6) | 886000 |
| A5 | 0.60 | 340.42 | 5.82 | 4− | @77.7 KU | 23150 (#6) | 780000 |
| A6 | 0.57 | 297.47 | 10.48 | 3+ | @84.7 KU | 18650 (#6) | 916000 |
| A7 | 0.57 | 277.14 | 15.10 | 3 | @85.7 KU | 22150 (#6) | 931000 |
| A11 | 0.62 | 268.01 | 14.30 | 3− | @81.6 KU | 12340 (#5) | 893000 |
| A12 | 0.62 | 282.54 | 15.97 | 3− | @81.6 KU | 10220 (#5) | 846000 |
| A13 | 0.65 | 255.30 | 17.02 | 3− | @91.9 KU | 6960 (#5) | 713000 |
| A14 | 0.60 | 217.91 | 20.54 | — | | 2730 (#4) | 447000 |
| A16 | 0.59 | 287.17 | 11.66 | 3 | @82.4 KU | 18350 (#6) | 985000 |
| A17 | 0.57 | 309.65 | 12.56 | 3+ | @84.8 KU | 21400 (#6) | 956000 |
| A18 | 0.57 | 304.33 | 12.19 | 3 | @84.4 KU | 21300 (#6) | 1030000 |
| A19 | 0.57 | 311.86 | 11.34 | 3+ | @84.4 KU | 17350 (#6) | 955000 |

Table 8 shows the experimental results of MHEC used as a rheology modifier in the base paint formulation.

TABLE 8

| | | | | | | Water | |
|---|---|---|---|---|---|---|---|
| | | | NMR % | | | Whitening | |
| | MHEC | MeDS/HeMS + | Unsub | Viscosity | SEC | Latex | |
| MHEC | Wt % | 100*MeDS | AGU | Pa · S | MW | (25° C.) | |
| CuIminal ™ | 0.57 | 165.82 | 12.73 | 8550 | 932000 | 3 | @77.8 KU |
| MC 7000 PF | | | | | | | |
| Combizell ® | 0.53 | 174.72 | 15.40 | 7050 | 1490000 | 3− | @80.1 KU |
| LH 70MS | | | | | | | |
| B1 | 0.57 | 206.18 | 6.20 | 21350 | 1040000 | 4− | @88.2 KU |
| B2 | 0.57 | 208.89 | 6.22 | 24100 | 964000 | 3+ | @91.0 KU |
| B3 | 0.57 | 185.23 | 8.22 | 26100 | 1500000 | 3+ | @88.2 KU |
| B4 | 0.57 | 202.19 | 7.90 | 13650 | 935000 | 4− | @83.0 KU |
| B5 | 0.57 | 205.33 | 8.22 | 23400 | 1160000 | 4− | @88.8 KU |
| B6 | 0.49 | 210.13 | 6.71 | 19000 | 1020000 | 4− | @79.4 KU |
| B7 | 0.57 | 206.48 | 7.07 | 12250 | 1060000 | 4− | @84.5 KU |
| B8 | 0.57 | 206.11 | 6.32 | 29950 | 1110000 | 3+ | @84.4 KU |

Inaredients listed in Table 8:
(1) Culminal™ MC 7000 PF: commercially available from Ashland Inc., USA
(2) Combizell® LH 70MS: commercially available from Hercules Tianpu Chemical Company Limited, China

Table 9 shows the experimental results of MC used as a rheology modifier in the base paint formulation.

TABLE 9

| | | | NMR % | Water Whitening | | | |
|---|---|---|---|---|---|---|---|
| | MC | Methyl | Unsub | Latex | | | Viscosity 2% |
| MC | wt % | DS | AGU | (25° C.) | | SEC MW | RV spindle #6 |
| Benecel ™ | 0.57 | 1.87 | 7.87 | 4− | @84.0 KU | 1070000 | 18650 |
| A40M | | | | | | | |
| C1 | 0.57 | 1.70 | 9.62 | 4− | @79.6 KU | 904000 | 20600 |
| C2 | 0.57 | 1.85 | 6.70 | 4− | @80.1 KU | 1030000 | 37400 |
| C3 | 0.57 | 1.95 | 6.74 | 4− | @85.0 KU | 759000 | 24600 |
| C4 | 0.51 | 1.98 | 7.44 | 3+ | @83 KU | 1140000 | 28350 |
| C5 | 0.57 | 1.43 | 18.10 | 3+ | @79.7 KU | 858000 | 18450 |
| C6 | 0.48 | 1.93 | 7.29 | 3+ | @85.0 KU | 1170000 | 40550 |
| C7 | 0.57 | 1.85 | 9.32 | 4− | @82.5 KU | 832000 | 23700 |
| C8 | 0.57 | 1.89 | 9.75 | 3+ | @82.7 KU | 943000 | 23650 |
| C9 | 0.57 | 1.94 | 7.63 | 3+ | @83.5 KU | 1030000 | 26150 |
| C10 | 0.57 | 1.88 | 6.76 | 4− | @82.8 KU | 838000 | 18050 |
| C11 | 0.63 | 1.02 | 26.60 | — | | 311000 | — |
| C12 | 0.75 | 1.35 | 8.69 | 3 | @85.0 KU | 804000 | 11150 |
| C13 | 0.62 | 1.50 | 14.73 | 3+ | @85.5 KU | 1160000 | 10850 |
| C14 | 0.57 | 1.84 | 7.84 | 3+ | @87.4 KU | 983000 | 18250 |
| C15 | 0.57 | 1.84 | 10.0 | 3+ | @83.6 KU | 1430000 | — |
| C18 | 0.55 | 1.97 | 7.23 | 4− | @83.6 KU | 968000 | 20750 |

(1) Benecel ™ A40M: commercialy available from Ashland Inc., USA

Preparation of Stone Paint Formulation Having Cellulose Ethers in Combination with Synthetic Associative Thickeners (SATs) and Test for Water Whitening and Soravability

Water whitening performance of a stone paint formulation containing a base paint formulation and a sand was evaluated based on the coating film prepared from a mixture comprising a latex emulsion, a rheology modifier, a coalescing agent, a biocide, a neutralizing agent, a solvent, and a sand.

An aqueous solution of cellulose ether was prepared using the procedures known in the art. Desired amounts of the cellulose ether solution were added to a mixture of 48 g of RS-991 and 1.6 g of Texanol™. Different types of synthetic associative thickeners listed in Table 11 were added with the desired dosages and mixed for 1 hr to adjust the base paint to approximately 85 KU. The pH of the base paint was adjusted by addition of few drops of AMP-95™ to 8.5-9.0 and about 0.4 g of Kathon™ LXE was added to form a base paint formulation. One part of the base paint formulation was mixed with three parts of a sand mixtures by weight to form a uniform mixture (a stone paint formulation). The sand mixture contained about 9.3 wt % 20-40 mesh sands, about 60 wt % 40-80 mesh sands and about 30.7 wt % of 80-120 mesh sands.

The stone paint formulation was sprayed on a cement fiber board having the area of 10×15 cm using a spray gun. The board was sealed with approximately 30 grams of primer and allowed to dry completely prior to spraying the stone paint formulation. The spray gun was connected to a compressed air cylinder and was operated at 0.4 MPa to spray the stone paint formulation onto the board of the designated area for 8 seconds to form a stone paint panel. The spray application feel was recorded on a subjective rating scale from 5 to 1, where 5=best, continuous and uniform spray application out of the nozzle; 1=worst, discontinuous or sputtering spray from the nozzle. The weight of the stone paint dispensed out in 8 seconds was recorded in grams. Typically the high numbers indicate better sprayability. The stone paint panels were then dried for 5 hours under controlled temperature (22-25° C.) and humidity (55%). The panels were subjected to a water whitening test by soaking in water at water bath (23-25° C.). The water whitening was assessed by assigning a rating listed in Table 10 after 4 hours of soaking in water.

TABLE 10

| Rating | Description |
|---|---|
| 5 | No Whitening |
| 4 | Slight whitening |
| 3 | Moderate whitening |
| 2 | Severe whitening |
| 1 | Opaque |

Table 11 shows the experimental results of various combinations of cellulose ethers and synthetic associative thickeners used as a rheology modifier in stone paint formulation.

TABLE 11

| Cellulose Ether | | SAT | | Base | Stone Paint | | |
|---|---|---|---|---|---|---|---|
| | wt % in | | wt % in | Paint | Panel Water | | |
| | base | | base | Viscosity | Whitening | Sprayability | Sprayability |
| Sample | paint | Sample | paint | (KU) | Rating | Feel Rating | Weight, g |
| HBR 250 | 0.67 | — | — | 84.3 | 2 | 4 | 93.3 |
| HBR 250 | 0.40 | Aquaflow ™ | 0.15 | 85.7 | 3+ | 4 | 87.0 |
| | | NLS 200 | | | | | |
| HBR 250 | 0.40 | Aquaflow ™ | 0.25 | 86.7 | 3+ | 3+ | 85.3 |
| | | NMS 450 | | | | | |
| HBR 250 | 0.40 | Acrysol ™ | 0.47 | 79.5 | 4 | 5 | 98.2 |
| | | TT-935 | | | | | |
| HBR 250 | 0.35 | Adekanol ™ | 0.35 | 86.4 | 2+ | 4 | 91.3 |
| | | UH752 | | | | | |
| A40M | 0.60 | — | — | 87.0 | 4 | 5 | 105.0 |
| A40M | 0.40 | Aquaflow ™ | 0.15 | 85.5 | 4 | 4 | 89.0 |
| | | NLS 200 | | | | | |
| A40M | 0.40 | Aquaflow ™ | 0.18 | 85.2 | 4+ | 5 | 96.9 |
| | | NMS 450 | | | | | |
| A40M | 0.40 | Acrysol ™ | 0.48 | 92.9 | 4+ | 5 | 103.5 |
| | | TT-935 | | | | | |
| A40M | 0.30 | Adekanol ™ | 0.41 | 86.2 | 4+ | 4 | 93.1 |
| | | UH752 | | | | | |
| B8 | 0.58 | — | — | 85.0 | 4− | 5 | 103.7 |
| B8 | 0.40 | Aquaflow ™ | 0.12 | 85.5 | 4+ | 4 | 91.0 |
| | | NLS 200 | | | | | |
| B8 | 0.40 | Aquaflow ™ | 0.18 | 85.9 | 4+ | 4 | 91.7 |
| | | NMS 450 | | | | | |
| B8 | 0.40 | Acrysol ™ | 0.45 | 85.3 | 4+ | 4 | 93.5 |
| | | TT-935 | | | | | |
| B8 | 0.40 | Adekanol ™ | 0.23 | 85.7 | 4+ | 4 | 92.1 |
| | | UH752 | | | | | |
| A3 | 0.57 | — | — | 84.4 | 3+ | 3+ | 85.3 |
| A3 | 0.40 | Aquaflow ™ | 0.11 | 84.2 | 4 | 3 | 81.6 |
| | | NLS 200 | | | | | |
| A3 | 0.40 | Aquaflow ™ | 0.16 | 85.2 | 4 | 3 | 80.7 |
| | | NMS 450 | | | | | |
| A3 | 0.40 | Acrysol ™ | 0.35 | 85.9 | 4 | 1 | — |
| | | TT-935 | | | | | |
| A3 | 0.40 | Adekanol ™ | 0.25 | 84.6 | 4 | 3+ | 87.0 |
| | | UH752 | | | | | |

(1) HBR250: refers to Natrosol ™ 250HBR, commercially available from Ashland Inc., USA
(2) A40M: refers to Benecel ™ A40M: commercially available from Ashland Inc., USA
(3) Aquaflow ™ NLS 200: commercially available from Ashland Inc., USA
(4) Aquaflow ™ NMS 450: commercially available from Ashland Inc., USA
(5) Acrysol ™ TT-935: commercially available from The Dow Chemical Company, USA
(6) Adekanol ™ UH752: commercially available from Adeka Corporation, Japan

1. A stone paint formulation comprising a composition A and a composition B, wherein the composition A comprises a latex emulsion, a rheology modifier, a coalescing agent, a biocide, a neutralizing agent and a solvent; and the composition B comprises a sand.

2. The stone paint formulation of claim 1, wherein the latex emulsion is acrylic latex.

3. The stone paint formulation of claim 2, wherein the acrylic latex is styrene acrylate.

4. The stone paint formulation of claim 3, wherein the styrene acrylate is selected from the group consisting of a styrene ethyl acrylate copolymer, a styrene-methyl meth acrylate-n-butyl acrylate copolymer, a styrene-butyl acrylate copolymer, and combinations thereof.

5. The stone paint formulation of claim 1, wherein the rheology modifier is cellulose ether.

6. The stone paint formulation of claim 5, wherein the cellulose ether is selected from the group consisting of methyl hydroxyethyl cellulose (MHEC), methyl hydroxypropyl cellulose (MHPC), methyl cellulose (MC), and combinations thereof.

7. The stone paint formulation of claim 6, wherein the cellulose ether is the methyl hydroxyethyl cellulose having [MeDS/HeMS+100*MeDS] greater than 180.

8. The stone paint formulation of claim 6, wherein the cellulose ether is the methyl hydroxypropyl cellulose and [MeDS/HpMS+180*MeDS] is greater than 295.

9. The stone paint formulation of claim 6, wherein the methyl cellulose has a degree of substitution of methyl group (MeDS) greater than 1.40.

10. The stone paint formulation of claim 6, wherein the cellulose ether is hydrophobically modified.

11. The stone paint formulation of claim 10, wherein the hydrophobically modified cellulose ether comprises hydrophobically modified hydroxyethyl cellulose (HMHEC).

12. The stone paint formulation of claim 11, wherein the hydrophobically modified hydroxyethyl cellulose is C4 glycidyl HMHEC.

13. The stone paint formulation of claim 1, wherein the biocide is selected from the group consisting of tolylfluanid, N-cyclopropyl-N′-(1,1-dimethylethyl)-6-(methylthio)-1,3,5-triazine-2,4-diamine, tetrachloroisophthalonitrile, N-(trichloromethylthio)phthalimide, propiconazol, tebuconazol, octyl-isothiazolinone, dichlor-isothiazolinone, ter-bythryn, zinkpyrothione, fipronil, thiamethoxam, chlorfenapyr and thiachloprid, and combinations thereof.

14. The stone paint formulation of claim 1, wherein the neutralizing agent is 2-amino-2-methyl-1-propanol.

15. The stone paint formulation of claim 1, wherein the neutralizing agent is N-alkyldialkanolamines.

16. The stone paint formulation of claim 15, wherein the N-alkyldialkanolamines is selected from the group consisting of N-alkyldiethanolamines, N-alkyldipropanolamines, and combinations thereof.

17. The stone paint formulation of claim 1, wherein the solvent is water.

18. The stone paint formulation of claim 1, wherein the sand comprises a 20-40 mesh sand, a 40-80 mesh sand, or a 80-120 mesh sand.

19. The stone paint formulation of claim 18, wherein the sand is selected from the group consisting of black sand, gray sand, white sand, red sand, and combinations thereof.

20. The stone paint formulation of claim 1, wherein the composition A further comprises a synthetic associative thickener (SAT).

21. The stone paint formulation of claim 20, wherein the NSAT is selected from the group consisting of polyacetal-polyether (PAPE), hydrophobically-modified ethoxylated urethane (HEUR), hydrophobically-modified polyethylene glycol (HMPEG), hydrophobically-modified polyacetal-polyether (HMPAPE), hydrophobically modified alkali-soluble emulsion (HASE), and combinations thereof.

22. The stone paint formulation of claim 1, wherein the composition A further comprises a pigment.

23. The stone paint formulation of claim 22, wherein the pigment is selected from the group consisting of hydrated aluminum oxide, barium sulfate, calcium silicate, lay, silica, talc, titanium dioxide, zinc oxide, magnesium aluminum silicate, and combinations thereof.

24. A method for preparing a base paint formulation, comprising the steps of:
(a) preparing a solution containing a rheology modifier and a solvent,
(b) adding the solution to a mixture containing a latex emulsion and a coalescing agent and mixing to form a base paint,
(c) adjusting the pH of the base paint using a neutralizing agent, and
(d) adding a biocide to the base paint to form the base paint formulation.

25. The method of claim 24, wherein the rheology modifier is cellulose ether selected from the group consisting of methyl hydroxyethyl cellulose (MHEC), methyl hydroxypropyl cellulose (MHPC), methyl cellulose (MC), and combinations of.

26. The method of claim 25, wherein the MHEC has [MeDS/HeMS+100*MeDS] greater than 180.

27. The method of claim 25, wherein the MHPC has [MeDS/HpMS+180*MeDS] greater than 295.

28. The method of claim 25, wherein the methyl cellulose has a degree of substitution of methyl group (MeDS) greater than 1.40.

29. The method of claim 25, wherein the rheology modifier further comprises a synthetic associative thickener (SAT).

30. The method of claim 29, wherein the NSAT is selected from the group consisting of polyacetal-polyether (PAPE), hydrophobically-modified ethoxylated urethane (HEUR), hydrophobically-modified polyethylene glycol (HMPEG), hydrophobically-modified polyacetal-polyether (HMPAPE), hydrophobically modified alkali-soluble emulsion (HASE), and combinations thereof.

31. A method for preparing a stone paint formulation, comprising adding a sand to the base paint formulation prepared from claim 24.
